(19) United States
(12) Patent Application Publication
(10) Pub. No.: US 2014/0004942 A1
(43) Pub. Date: Jan. 2, 2014

(54) METHODS AND SYSTEMS FOR PROVIDING COMMANDS USING REPEATING GEOMETRIC SHAPES

(71) Applicant: Peter Steinau, Los Angeles, CA (US)

(72) Inventor: Peter Steinau, Los Angeles, CA (US)

(21) Appl. No.: 13/894,370

(22) Filed: May 14, 2013

Related U.S. Application Data
(60) Provisional application No. 61/667,383, filed on Jul. 2, 2012.

(51) Int. Cl. A63F 13/12

(52) U.S. Cl. CPC A63F 13/12
USPC 463/31

(57) ABSTRACT

A method and system for providing input commands for an electronic application comprising providing an electronic application capable of being used on a plurality of electronic touch screen devices by one or more users, providing an application where when the user provides at least two of (1) inputting a specific geometric pattern on the electronic screen, (2) repeatedly inputting a specific section or sections of the electronic screen, (3) inputting the geometric pattern or specific section or sections with a specific rhythm or a specific number of times, the user causes a specific command to be performed in the application.

### RELATED APPLICATION

The present application is a non-provisional of U.S. Provisional Patent Application No. 61/667,383 filed on Jul. 2, 2012, the entire contents of which are incorporated herein by reference.

### FIELD OF THE DISCLOSURE

The present invention generally relates to the field of game application for mobile smartphone devices, tablet devices or any electronic touch screen devices. More particularly, the present invention relates to methods and related systems for mechanics and rules for playing a game providing commands using unique and/or repetitive geometric shapes.

### BACKGROUND

Mobile gaming applications are one of the most popular contents consumed by mobile users in today's mobile networks. Users can download one or more game applications from the online portal and then they own the game and upgrades/related content thereafter. Access and popularity of mobile gaming applications has increased dramatically over the years. New and interesting features, include but are not limited to, allowing the users to interact with other gaming enthusiasts who may be located at remote locations.

The advance in the field of telecommunications and computer technology has led to portable computers being able to connect to the Internet using wireless modems and also to mobile phones. The wireless networks provide the ability to one or more users to play the same game between different electronic devices irrespective of the geographic location of the users.

There exists a need to provide a method and system that is designed for providing a game application for one or more electronic touch screen devices that involve providing input commands by creating different geometric patterns on the electronic touch screen devices wherein the method involves swiping, holding, tapping of multiple dots at once using multiple fingers to create various levels of complexity for the users providing a real life battle experience for the users.

Currently, the mobile smartphone devices, tablet devices or electronic touch screen device involve tapping the dots one at a time by creating a specific pattern on the touch screen device for locking devices for privacy and data security. There exists a need for methods and systems for providing commands using repetitive shapes in combination with holding, tapping and swiping the dots on the screen of the electronic touch screen devices to provide users with high level of security.

### SUMMARY OF THE INVENTION

These and other features, aspects and advantages of the present invention will become better understood with reference to the following drawings, description and claims.

In one embodiment of the present invention, methods and systems for providing commands using repeating geometric shapes are provided.

In another embodiment of the present invention, methods and systems for providing a game application to be played on a smart phone device, a tablet device or an electronic touch screen device.

In yet another embodiment of the present invention, a method for providing input commands for an electronic application, the method comprising: providing an electronic application capable of being used on a plurality of electronic touch screen devices by one or more users, providing an application where when the user provides at least two of (1) inputting a specific geometric pattern on the electronic screen, (2) repeatedly inputting a specific section or sections of the electronic screen, (3) inputting the geometric pattern or specific section or sections with a specific rhythm or a specific number of times, the user causes a specific command to be performed in the application.

In yet another aspect of at least one embodiment of the present invention, a method for providing input commands for an electronic application wherein inputting specific commands allows the user to retrieve the stored data or perform a specific action or command quickly and securely.

In yet another aspect of at least one embodiment of the present invention, a method for providing input commands for an electronic application wherein providing specific input commands that allows the user to control or operate the devices and/or software.

In yet another aspect of at least one embodiment of the present invention, a method for providing input commands for an electronic application wherein the one or more users enter the input commands using the input grid.

In yet another aspect of at least one embodiment of the present invention, a method for providing input commands for an electronic application wherein the one or more users hold, tap or swipe the one or more dots on the input grid to enter the input commands.

In yet another aspect of at least one embodiment of the present invention, a method for providing input commands for an electronic application wherein the one or more users enter the input commands by creating one or more geometric patterns on the input grid.

In yet another aspect of at least one embodiment of the present invention, a method for providing input commands for an electronic application further comprising linking the one or more touch screen devices to each other by a central game server or over a network.

In yet another aspect of at least one embodiment of the present invention, a method for providing input commands for an electronic application further comprising sending game signals from one electronic touch screen device to the central game server or over a network.

In yet another aspect of at least one embodiment of the present invention, a method for providing input commands for an electronic application wherein the dots of the input grid are transparent.

In yet another aspect of at least one embodiment of the present invention, a method for providing input commands for an electronic application wherein the dots of the input grid are overlaid on the screen of the electronic application.

In yet another aspect of at least one embodiment of the present invention, a method for providing input commands for an electronic application wherein the input grid is a 3×3 matrix of dots.

In yet another aspect of at least one embodiment of the present invention, a method for providing input commands for an electronic application wherein the input grid is a 3×4 matrix of dots.

In yet another aspect of at least one embodiment of the present invention, a method for providing input commands for an electronic application wherein the input grid is a 4×3 matrix of dots.

In yet another aspect of at least one embodiment of the present invention, a method for providing input commands for an electronic application wherein the input grid is a heart shaped matrix of dots.

In yet another embodiment of the present invention, a system for providing input commands for an electronic application, the system comprising a plurality of electronic touch screen devices containing a processor and capable of being used by one or more users, the touch screen devices including an application where when the user provides at least two of (1) inputting a specific geometric pattern on the electronic screen, (2) repeatedly inputting a specific section or sections of the electronic screen, (3) inputting the geometric pattern or specific section or sections with a specific rhythm or a specific number of times, the user causes a specific command to be performed in the application.

In yet another aspect of at least one embodiment of the present invention, a system for providing input commands for an electronic application wherein inputting specific commands allows the user to retrieve the stored data or perform a specific action or command quickly and securely.

In yet another aspect of at least one embodiment of the present invention, a system for providing input commands for an electronic application wherein providing specific input commands that allows the user to control or operate the devices and/or software.

In yet another aspect of at least one embodiment of the present invention, a system for providing input commands for an electronic application further comprising linking the one or more touch screen devices to each other by a central game server or over a network.

In yet another aspect of at least one embodiment of the present invention, a system for providing input commands for an electronic application sending game signals from one electronic touch screen device to the central game server or over a network.

In yet another aspect of at least one embodiment of the present invention, methods and systems for providing a game application wherein team play is possible and multiple users can play against each other allowing networking and bonding of users within the game.

In yet another aspect of at least one embodiment of the present invention, the methods and systems for a game application involving creating patterns on the input grid or pattern to cast a spell.

In yet another aspect of at least one embodiment of the present invention, the methods and systems for a game application wherein the user has to create various simple to complex patterns by tapping, swiping or holding the dots on the screen of the game application to cast various spells.

In yet another aspect of at least one embodiment of the present invention, the methods and systems for a game application involve various dots set out as an input grid or pattern.

In yet another aspect of at least one embodiment of the present invention, the input grid or pattern is a 3×3 matrix, 3×4 matrix or a larger matrix.

In yet another aspect of at least one embodiment of the present invention, the input grid or pattern is a matrix of different shapes including but not limited to heart, star, octagon etc.

In yet another aspect of at least one embodiment of the present invention, the methods and systems for a game application wherein the input grid or pattern can be overlaid on the screen of the smart-phone.

In yet another aspect of at least one embodiment of the present invention, the methods and systems for a game application wherein the input grid or pattern can be separate from the screen (i.e. below or on the sides of the screen) of the electronic touch screen device for the user's clarity of vision.

In yet another aspect of at least one embodiment of the present invention, the methods and systems for a game application comprising a story mode wherein the story mode of the game application allows users to learn the various spell patterns.

In yet another aspect of at least one embodiment of the present invention, the methods and systems for a game application wherein the input command is one or more geometrical shape including but not limited to square, circle, oval, butterfly, rose.

In yet another aspect of at least one embodiment of the present invention, the story mode of the game application allows users to learn the various spell patterns

In yet another embodiment of the present invention, the methods and systems for a game application providing a secure locking mechanism for the electronic touch screen devices.

In yet another embodiment of the present invention, the methods and systems for providing commands using repetitive shapes in combination with holding, tapping and swiping the dots on the screen of the electronic touch screen devices to provide users with high level of security.

In yet another aspect of at least one embodiment of the present invention, the input commands or patterns can be demonstrated to the user by various means including but not limited to lighting up or changing colors, shapes or orientation of the dots. For example and not by way of limitation, blue would indicate swipe, red would indicate hold, green would indicate tap, and the shapes and orientation would indicate to the user to take or not take certain actions. Additionally objects appearing or approaching certain items or location on the screen, for example fireballs, moles, or missiles, overlaying arrows pointing in a certain direction or by a border would instruct the user to take or not take certain actions to input commands.

In yet another embodiment of the present invention, methods and systems are provided where inputting specific commands allows the user to retrieve the stored data or perform a specific action or command quickly and securely.

In yet another embodiment of the present invention, the methods and systems include providing specific input commands that allow the user to control and/or operate the devices and/or software.

In yet another aspect of at least one embodiment of the present invention, one or more input commands are provided using a specific rhythm to achieve a specific result. If the input command is not entered in the specific rhythm needed, the action or inaction is not performed.

In yet another aspect of at least one embodiment of the present invention, inputting the specific rhythm along with the specific pattern unlocks a specific action or device.

### BRIEF DESCRIPTION OF THE DRAWINGS

FIG. 1A illustrates the game screen of the game application according to an embodiment of the present invention.

FIG. 1B illustrates the control screen of the game application according to an embodiment of the present invention.

FIG. 2 illustrates one or more aspects of casting different spells by creating various patterns on the game screen according to one or more embodiment of the present invention.

FIG. 3 illustrates one or more aspects of casting Starting Spells by creating various patterns on the game screen according to one or more embodiment of the present invention.

FIG. 4 illustrates one or more aspects of casting Attack Spells by creating various patterns on the game screen according to one or more embodiment of the present invention.

FIG. 5 illustrates one or more aspects of casting Defensive Spells by creating various patterns on the game screen according to one or more embodiment of the present invention.

FIG. 6 illustrates one or more aspects of casting Summons by creating various patterns on the game screen according to one or more embodiment of the present invention.

FIG. 7 illustrates one or more aspects of performing Transmute by creating various patterns on the game screen according to one or more embodiment of the present invention.

FIG. 8 illustrates one or more aspects of casting Fire Land Spells by creating various patterns on the game screen according to one or more embodiment of the present invention.

FIG. 9 illustrates an embodiment of the present invention, the system for providing the electronic game application to the one or more users.

FIG. 10 illustrates an embodiment of the present invention where a specific input command is provided to retrieve specific data.

FIG. 11 illustrates the method for holding specific inputs for a period of time and selecting different inputs in combination to cause certain actions to be performed.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced. The following description is not to be taken in a limiting sense, but is made merely for the purpose of illustrating the general principles of the invention, since the scope of the invention is best defined by the following claims. It is to be understood that other embodiments may be utilized as changes may be made without departing from the scope of the present invention.

It should be noted that the present invention is adaptable for use on any operating system, including, but not limited to, Apple, Android, Windows, and Linux, using any known code or operating system.

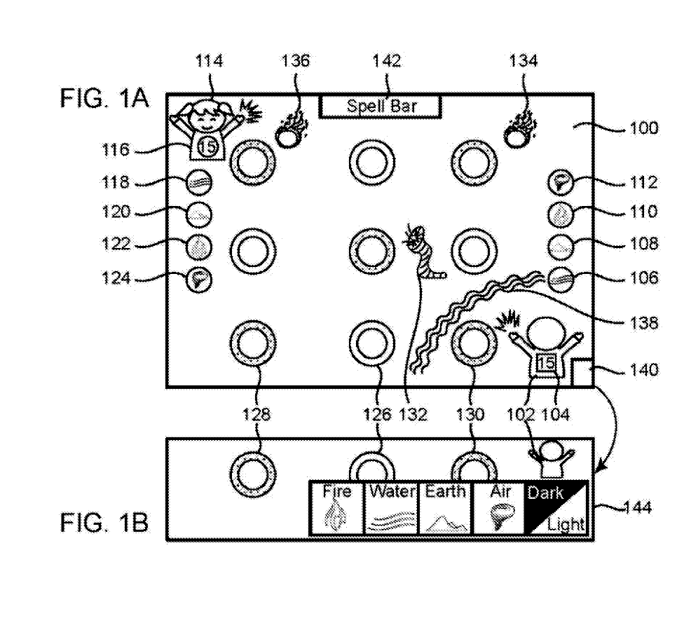

FIG. 1A shows the screen 100 of the game application according to an embodiment of the present invention. As shown in the FIG. 1A, the avatar of the user 102 is shown in the bottom right corner of the game application screen 100. The number 104 on the back of the user's avatar 102 represents the number of lives the user has remaining. The Water Land Icon 106 shows the number of Water Land Spells the user has put into play. The Earth Land Icon 108 shows the number of Earth Land Spells the user has put into play. The Fire Land Icon 110 shows the number of Fire Land Spells the user has put into play. The Wind Land Icon 112 shows the number of Wind Land Spells the user has put into play. The opponent's avatar 114 is shown in the upper left corner of the game application screen 100. The number 116 on the back of the opponent's avatar 114 represents the number of life the opponent has remaining.

As shown in the FIG. 1B, there are four basic elements of the game, namely Fire, Water, Earth and Air. The Water Land Icon 118 shows the number of Water Land Spells the user has put into play. The Earth Land Icon 120 shows the number of Earth Land Spells the user has put into play. The Fire Land Icon 122 shows the number of Fire Land Spells the user has put into play. The Wind Land Icon 124 shows the number of Wind Land Spells the user has put into play. In one embodiment of the present invention, the game application screen 100 comprises a 9 dot grid. In one aspect of at least one embodiment of the present invention, the grid could be bigger or smaller based on different levels of the game. The dots on the 9 dot grid are transparent so that they can be layered over the game application screen 100 or on a touch screen separate from the game screen. The dots can be held, tapped, swiped allowing users to create different patterns on the grid. To clear each level of the game application and to win against the opponent, the user has to cast spells using the 9 dot grid on the screen 100 of the game application. To unlock each spell, the user has to create a specific pattern on the screen using the 9 dot grid. To win the game, the user has to cast spells on his opponent by creating various patterns on the screen of the game application.

In yet another aspect of at least one embodiment of the present invention, the color of the dots can guide the user through a pattern or indicate that an attack from the opponent is nearing.

In yet another aspect of at least embodiment of the present invention, the dots on the screen can light up with different colors indicating a specific action. For example, in FIG. 1A, the single hatched dots are of yellow color indicating that those dots need to be tapped or swiped whereas the crosshatched dots are of red color indicating that those dots need to be held. As shown, the dots with single hatch 128 indicate yellow color. As shown, a diagonal line of single hatched dots, running from the bottom left dot 128 to the middle dot 146 to the top right dot 148, can indicate the pattern to be created to cast a specific spell. In yet another aspect of at least one embodiment of the present invention, the color of the dots can have gradation, for example dark yellow to light yellow, indicating the direction in which the dots need to be swiped or tapped. In yet another aspect of at least one embodiment of the present invention, the dots with cross hatched 130 indicate red color. As shown, the bottom right dot 130 and the top left dot 150 are red in color requiring the users to hold those dots to unlock the spell. To unlock the spell shown in FIG. 1A, the user has to hold the dots 130 and 150 while swiping through the dots 128, 146 and 148, requiring the user to use at least three fingers at a time.

As shown in FIG. 1A, 132 indicate the avatar of a summoned creature the user has put into play. Each creature is specific to the four elements namely Fire, Water, Earth and Air of the game. A user as well as the opponent can put up to four summoned creatures into play at a time, each creature signifying one of the four elements of the game.

In yet another aspect of at least one embodiment of the present invention, the game application includes a blocking mode wherein the opponent's attack approach the dots from a three dimensional perspective. In the blocking mode, the opponent's attacks (for example the fireballs) get larger when they approach closer to the dot. In the blocking mode the user will have to tap or hold the dots at a specific time when the attack enters the ring of the dots. The user is indicated of the specific time the dot needs to be tapped or held when those specific dots light up or change colors, for example, when on turning red from yellow. Simultaneously, the users might have to block multiple attacks entering the dots requiring them to use multiple fingers at a time. The attacks can be slow to fast, making it easier or harder for the user to block the attacks.

As shown in FIG. 1A, the crosshatch dot 136 indicates an attack approaching the dots wherein the user has to tap the dot to block it from the approaching attack. The game application has two modes: a regular mode and a blocking mode. FIG. 1A shows both the modes simultaneously wherein the crosshatched dots indicate that the attacks are approaching attacks and that the user can hold that dot to perform a pattern on the screen. In yet another aspect of at least one embodiment of the present invention, the story mode of the game application allows users to learn the various spell patterns

As shown in FIG. 1A, the wavy lines 138 originating from the Water Land Icon 106 indicates the image of the defense put into play by the user. In yet another aspect of at least one embodiment of the present invention, the shape and color of the defense might change depending on the level of the defense, which is determined by the number of times a user has increased the power of the particular element. For example, the Water Defense might change from a small stream to a powerful river as more Water Land Spells are cast and as the Water Defense Spells get proportionately more powerful. In yet another aspect of at least one embodiment of the present invention, one Defense may be cast for each element casting up to four different Land Spells at a time making the Defenses originate from the other Land Icons simultaneously.

As shown in FIG. 1A, the book shaped black button 140 at the bottom right corner of the game screen indicates the Spell Book. The user can tap on the button 140 to open up the Spell Book Menu 144 which allows the user to select the spell to be casted. As shown in the FIG. 1B, the spells are categorized on basis of the four elements of the game, namely Fire, Water, Earth and Air and a fifth category for light and dark spells. In yet another aspect of at least one embodiment of the present invention, once the user chooses the element for casting the spell, the user can choose from various spells including but not limited to attack spells, defense spells, level up spells by casting a land spell, summon a creature or trap spell. The Spell Book Menu closes once the user has selected the spell he desires to cast. Once the user has selected the spell, the dots on the screen light up based on the spell selected by the user and guide the user to create the pattern of the spell on the screen 100 of the game application.

As shown in FIG. 1A, the Spell Bar button 142 on the top center of the game screen indicates the amount of time the user has to cast a specific spell. In yet another aspect of at least one embodiment of the present invention, the users have an option of playing in the Free Play mode wherein the users can cast multiple spells without any time restriction. In yet another aspect of at least one embodiment of the present invention, the Spell Bar 142 indicates the spell the opponent is intending to use if the opponent is using the Spell Book.

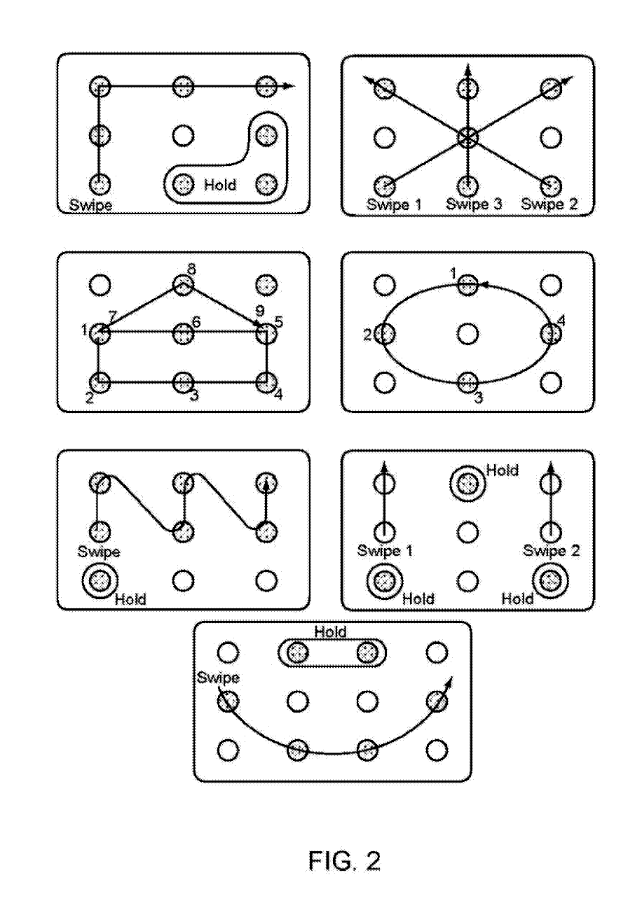

FIGS. 2-8 illustrate one or more aspects of playing the game application by casting different types of spells of the present invention.

FIG. 2 illustrates one or more aspects of casting different spells by creating various patterns on the screen of the game application. As shown in FIG. 2, the dots with single hatched lines need to be swiped and the dots with cross hatched lines need to be held to perform a pattern for casting a spell.

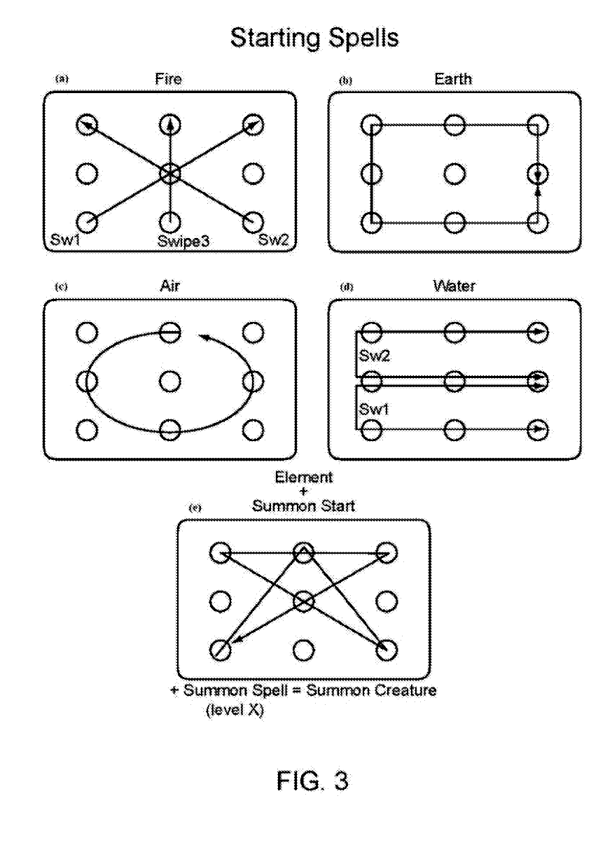

FIG. 3 illustrates the basic Starting Spells of the game application. Fire, Earth, Air and Water are the four basic elements for the game application and each of the four elements have a specific spell. FIG. 3a shows the Fire spell. FIG. 3b shows the Earth spell. FIG. 3c shows the Air spell. FIG. 3d shows the Water spell. Each of the four basic elements can also be used in combination with a summon spell as shown in FIG. 3e.

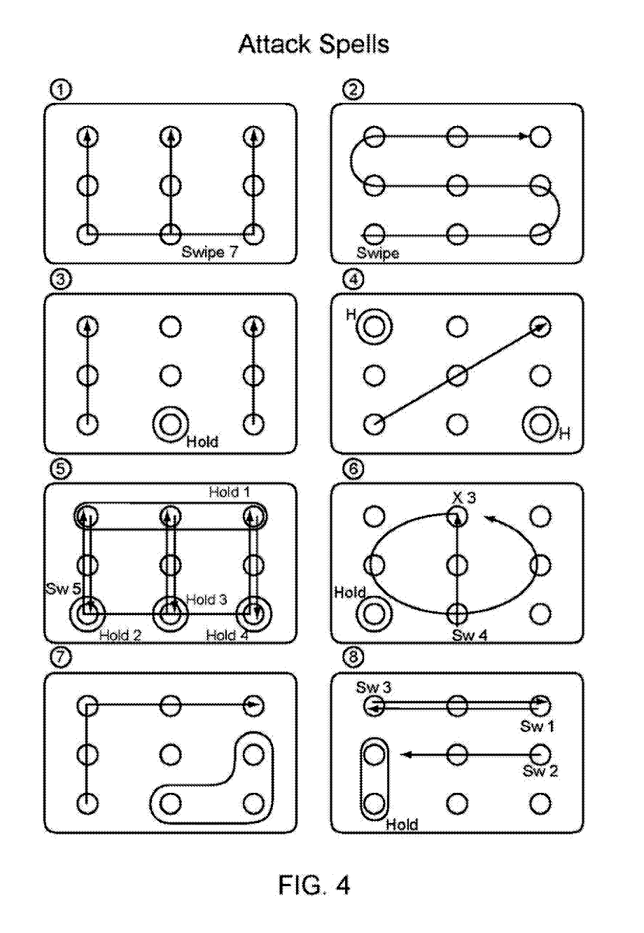

FIG. 4 illustrates the Attack Spells of the game application.

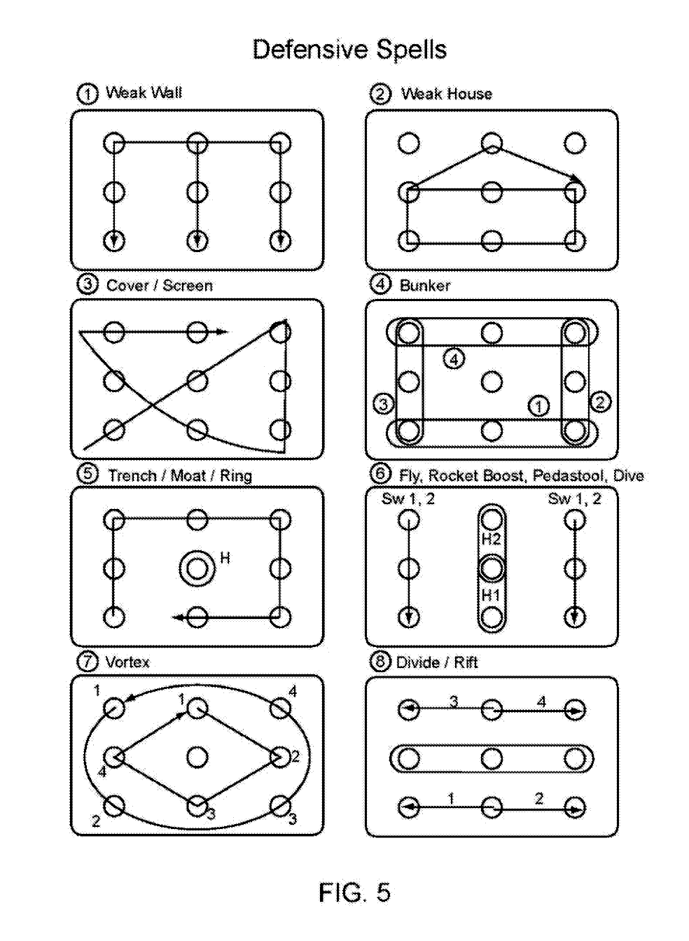

FIG. 5 illustrates the Defense Spells of the game application.

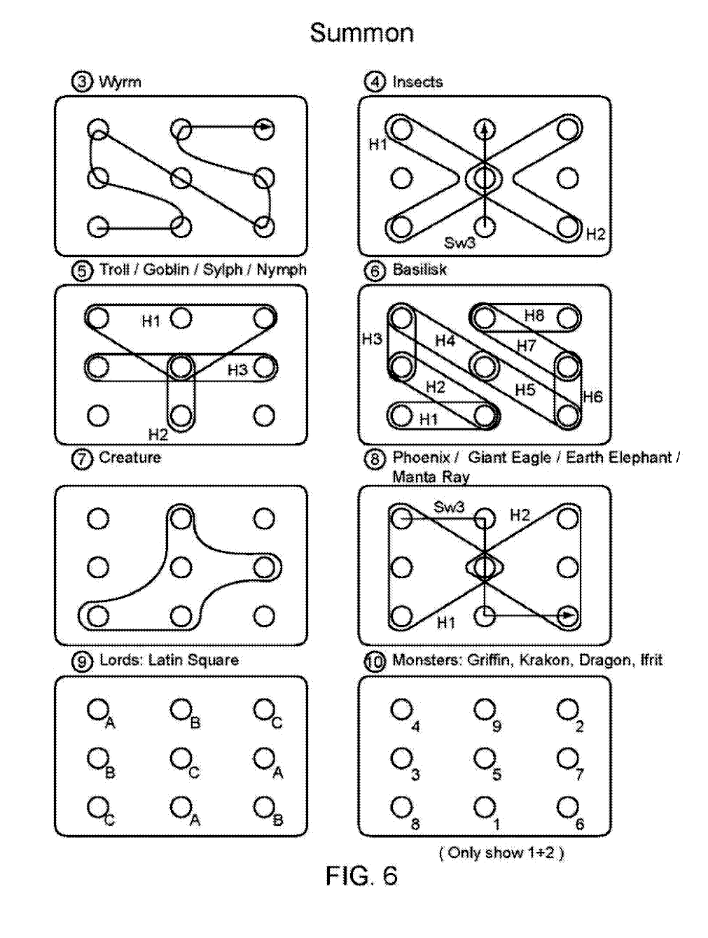

FIG. 6 illustrates the Summon Spells of the game application.

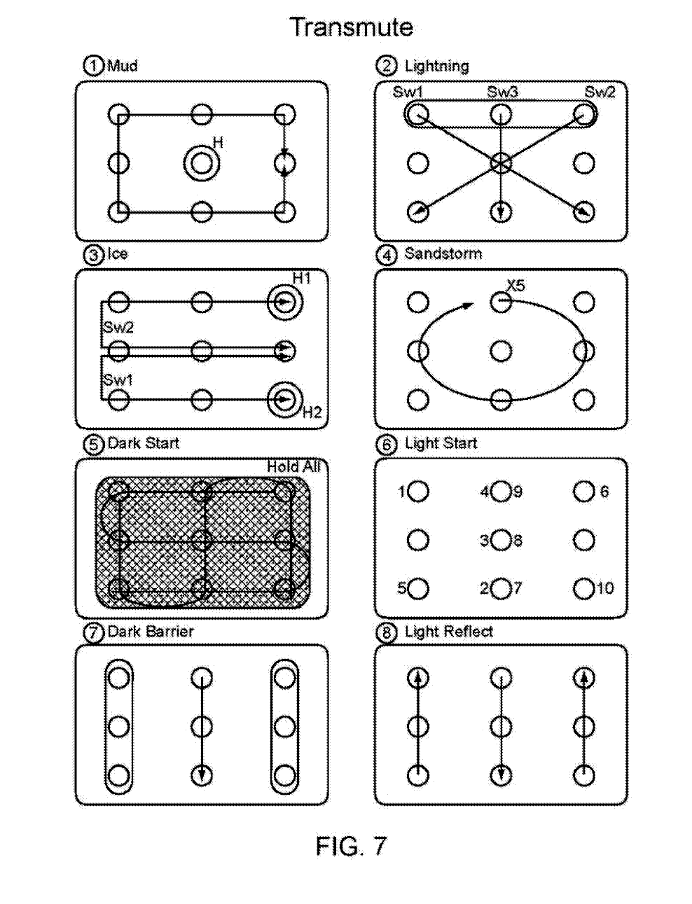

FIG. 7 illustrates the Transmute Spells of the game application.

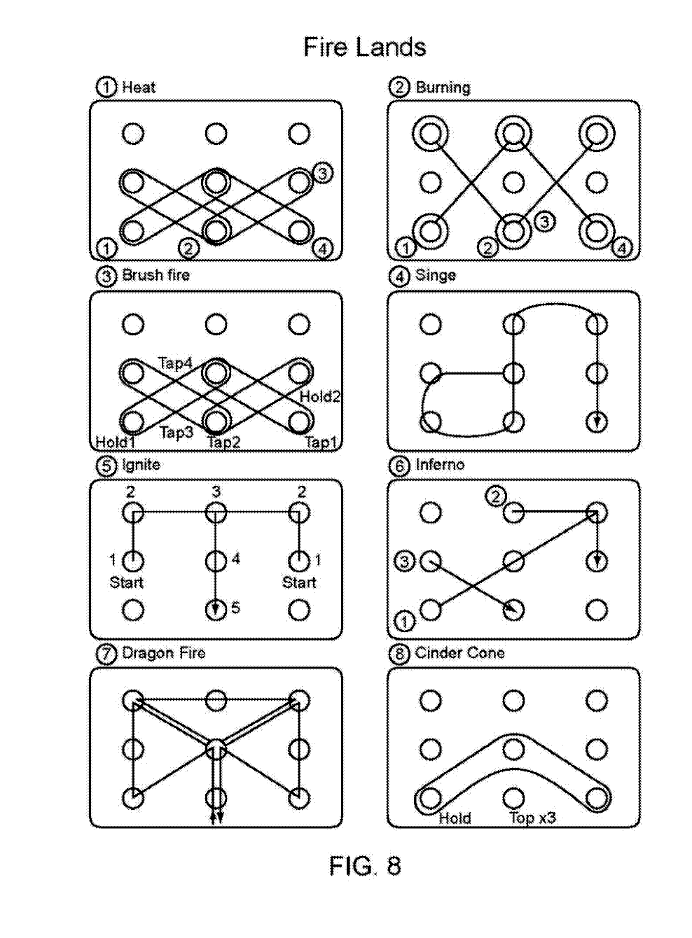

FIG. 8 illustrates the Fire Land Spells of the game application.

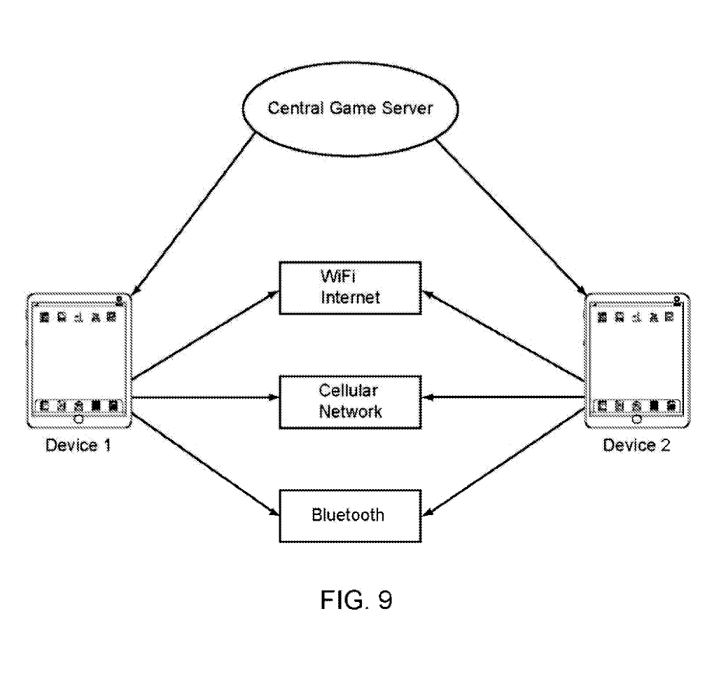

FIG. 9 illustrates in one embodiment of the present invention, the system for providing the electronic game application to the one or more users. As shown in FIG. 9, the devices for using the application are connected by the central game server. In yet another aspect of at least one embodiment of the present invention, the one or more devices can be connected to each other by various means including but not limited to any known means of transmitting and receiving data, including but not limited to a local network, cellular network, Bluetooth, WiFi® or the Internet.

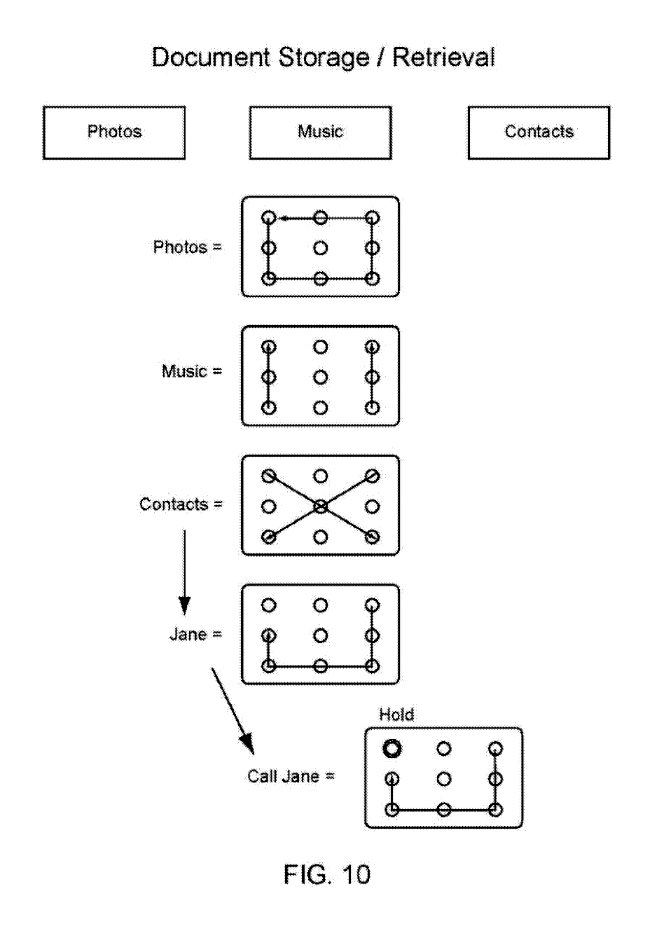

FIG. 10 illustrates an embodiment of the present invention, the method for providing input command for retrieval of data.

In yet another aspect of at least one embodiment of the present invention, the methods of the present invention can be applied to organize and retrieve data.

In yet another aspect of at least one embodiment of the present invention, specific data can be assigned a specific pattern that can be used to quickly and securely retrieve that data. In yet another aspect of at least one embodiment of the present invention, all the data including but not limited to photos, music, contacts are assigned specific patterns, examples of which are shown in FIG. 10.

For example, if a square pattern is assigned to photos, then whenever a square pattern input command is inserted, it quickly and securely calls up all the photos. In yet another aspect of at least on embodiment of the present invention, another specific pattern could bring up another specific secured photo. For example, as shown in FIG. 10, an “X” shaped pattern could bring up all the contacts and further a “J” shaped pattern could bring up specific contact details for Jane. Further if a “J” shaped pattern is created while holding the top left button on the grid, it could indicate to call Jane.

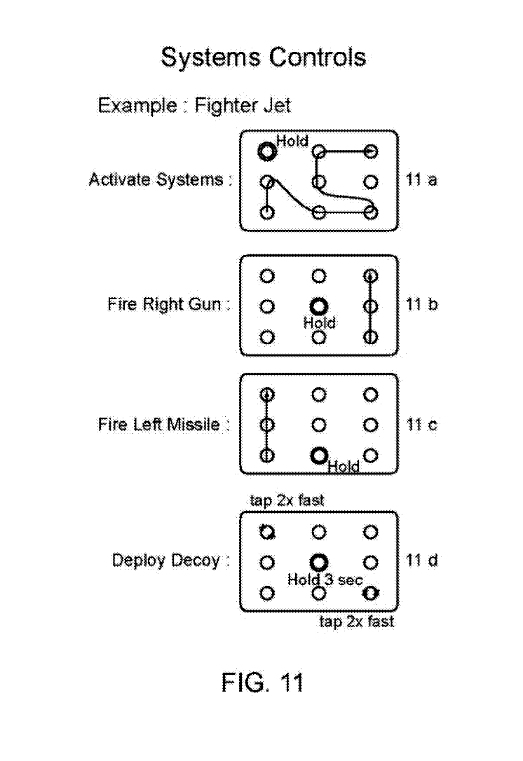

FIG. 11 illustrates yet another embodiment of the present invention where providing specific input commands allows the user to for controlling and operating various systems or cause certain actions to be performed, in an application or the operating system of the device.

In yet another aspect of at least one embodiment of the present invention, a pre-programmed control system is used to provide a secure method of using a secure system, for example, a weapon system on a fighter jet.

In yet another aspect of at least one embodiment of the present invention, each action is assigned a specific pattern to activate that action.

In yet another aspect of at least one embodiment of the present invention, the method of providing input commands can be used for any control system and has added benefit of being encoded.

For example, as shown in FIG. 11, in a fighter jet various actions such as activating the system, firing right gun, firing left missile, deploying decoy are assigned specific patterns. For example, as shown in FIG. 11a, holding the top left button and swiping a pattern can activate the system. As shown in FIG. 11b, holding the center button and swiping up the dots on the right side would fire the right gun. As shown in FIG. 11c, holding the center button in the bottom row and swiping up the dots on the left side would fire the left missile. As shown in FIG. 11d, tapping the top left button and bottom right button twice quickly along with holding the center button for 3 seconds will deploy decoy.

In yet another aspect of at least one embodiment of the present invention, the methods and systems for providing input commands can be used for specific actions in a battle field. In yet another aspect of at least one embodiment of the present invention, each input command pattern is specific to sending different troops in the battle, for example, marines, air force, navy or the kind of weapons to be used by those troops.

In yet another aspect of at least one embodiment of the present invention, methods and systems for providing input command wherein inputting the specific rhythm along with the specific pattern unlocks a specific action or device.

### Game Description

At the start of the game, each user has 15 lives. A user can choose from the various different game modes of the game application. In one embodiment of the game application, there are two modes, namely round based mode and live play game mode. In the round based game mode, the users have 15 seconds to cast a spell whereas in the live play game mode, the users have to cast spells as quickly as possible.

A user can choose from various different playing options such as multi-user play or team play. In a multi-user game, various users play at a time against each other. In a multi-user game option, all the users start in the arena at the same time. Each user decides either to defend, to cast spells or to pick a user to attack until only one user is remaining. The option of team play and multi-user play allows the users to network and bond with other users within the game.

There are four basic elements of the game application, namely, Water, Fire, Earth and Air. According to the rules of the game, Water beats Fire, Fire beats Earth, Earth beats Air and Air beats Water. There are four basic spell types, namely, Defense Spells, Attack Spell, Land Spells and Summon Spells. Land Spells are used to increase and level up the power and intensity of the spells. In each round, the user has to choose an Element and a type of Spell to cast. Different levels have different types of spells. Certain spells unlock only after the user has cleared certain levels of the game application. The users have to cast a Land Spell for each element before being able to cast any other set of spells. The user cannot cast the same spell twice in a row. The rules of the game include various limitations such as, once the element's Defense is destroyed, the user cannot use that element for defense anymore. Also, the user can cast only one Defense spell and can summon only one creature at a time per element. The higher level Defense spell or Summon spell will replace the lower level spells. A summoned creature can defend immediately but has to wait a turn or 15 seconds to attack. The Attack and Defense spells are the same for each of the four elements but the Land spells are different for each of the four elements.

Along with the four basic element spells, the Light and Dark spells are provided to increase or decrease the power and intensity of the spells. To unlock the Dark spells, the user has to cast any level 5 Land spell similarly the user has to cast any Level 6 spell to unlock the Light spells. The power and intensity of each of the Dark and Light spells differs based on the Levels. For Example, Level 5 Dark is 50 Defense, Level 6 Light is 70 Defense, Level 7 Dark is 35 Attack, Level 8 Light is 40 Attack, Level 9 Dark is 90 Defense and Level 100 Light is 100 Defense. The user cannot use a Light spell if a Dark spell has been used. Also, the Dark spells do not have any bonuses. A Light spell gets 50% bonus over Dark spell and attacks Dark Defenses first whereas a Light spell gets −50% against other elements.

The Defense Spells are 50% stronger than the Attack Spells and last until they are destroyed. By choosing a Land Spell, the user can increase power of the Attack and Defense Spells which also increases the Bonus in proportion. The game has various levels including but not limited to Level 1 that has 5 Attack Power and 10 Defense Power moving through Level 10 that has 50 Attack Power and 100 Defense Power. The Summon Spells for each element are available only after two Land Spells for that element have been casted. Before the Summon Spell can be used, the Summoned Creatures provide half the defense of a normal Defense spell at that level and Summoned Creatures attack with the power of that level after waiting one round. The users receive bonus points based on the spells they choose. For example, the Fire Spells gain bonus against Earth Spells, Earth Spells receive bonus against Air Spells, Air Spells receive bonus against Water Spells and Water Spell receives bonus against Fire Spells. Also, the Water Attack Spells receive a 100% bonus versus the Fire Defense Spell. The bonus is awarded to the winning attack or defense including when a creature attacks or defends. If the Attack spell wins against the Defense spell, it earns a bonus equal to the power of that Attack spell but will not be higher than the defensive strength of the defending element. If the Defense spell wins against an Attack spell, the bonus is determined by the level of the game, but will not exceed the total power of the Attack spell.

The Transmute spells, as shown in FIG. 7, transform the four basic element of the game wherein Water is transmutes to Ice, Fire transmutes to Lightning, Earth transmutes to Mud and Air transmutes to a Stand-storm. The Transmute spells are available to the user once level 5 has been reached and reverses the element advantage and bonus for that element, for example, Fire gets bonus against Ice, Mud gets bonus against Fire. In an embodiment of the present disclosure, the ice spell can be accessed after transmuting water to ice which reverses the bonus. Fire gets bonus against water, but water gets bonus against lighting which is the transmuted version of fire.

In yet another aspect of at least one embodiment of the present invention, the defensive priority automatically uses the defense that has element advantage. In yet another aspect of at least one embodiment of the present invention, normal defenses usually defend before summoned creatures. In yet another aspect of at least one embodiment of the present invention, if no normal defense in play gets an element bonus, but a creature does, it takes damage and gets a bonus. In yet another aspect of at least one embodiment of the present invention, if two defenses are off element and there is no bonus, they split the damage.

The users have the option of using the spell book that guides the users through a spell by lightning up the specific pattern on the 9-dot grid. If the user uses the spell book to cast the spell instead of casting spells from memory, the opponent will be able to view the spell the user will be casting.

One more category of spells is the Trap spells. The Trap spells are available for an element only after the users have cleared level 7 of the game application. When the user uses a Trap spell and the opponent casts a creature of the element that is weaker or at the same level strength, the creature will be killed instantly and will not be able to defend. When a Trap spell is cast without using the Spell Book in Round play mode, the opponent will not be able view the spell casted by the user and it will appear to the opponent as if no spell was cast.

According to the rules of the game application, there is no best strategy to play the game but is based on a predictability model. Each user has to take into consideration all the past moves and spells used by the opponent and based on that the user predicts his/her next move. The game application requires thinking strategically as the winners and losers are not determined in one round.

### GAME EXAMPLES

The following are few examples describing the methods for playing the game application:

### Example 1

In one example of the game application, the game starts with two attack spells. When User 1 casts a Water Attack spell and user 2 casts a Fire Attack spell, both the users have 5 damages to their life.

### Example 2

In another example of the game application, the game starts with Attack spell against Defense spell. When User 1 casts Water Attack spell (5 Attack) and User 2 cast Fire Defense spell (10 Defense), User 1 gets 5 bonus points whereas User 2's spell is destroyed.

### Example 3

In yet another example of the game application, the game starts with a Land Spell. In Round 1, when User 1 casts a Water Land spell and User 2 casts a Fire Attack spell, User 1 gets a 5 damage to life whereas User 2 is unharmed. User 1 can also use the Level 2 Water spells. In Round 2, when User 1 casts Water Attack Level 2 and User 2 casts Air Defense Level 1, User 2 gains 5 bonus points, gets 5 life damage and has 5 Defense left whereas User 2 has all 15 life left.

### Example 4

In yet another example of the game application, the game starts at Level 3 with a Summon spell. User 1 casts Level 3 Air Attack whereas User 2 casts Level 3 Fire Summon. User 2's Fire Creature has 15 Defense, but since Air and Fire are “Off elements” no bonus is awarded to the attack or defense spells and User 2's Fire Creature is killed.

### Example 5

In yet another example of the game application, the game starts at Level 5 with Attack against Defense. When User 1 casts Level 5 Water Attack (25 points) and User 2 casts Level 5 Fire Defense (50 points), User 1 gets 25 bonus points against Fire and User 2's Fire Defense is destroyed.

### Example 6

In yet another example of the game application, the game has a no Attack bonus “Spill Over”. When User 1 casts Level 3 Water Attack (15 points) and User 2 casts Level 1 Fire Defense (10 points), User 1 gets 15 bonus points against Fire and User 2's Fire Defense is destroyed and gets 15 additional life damages.

It should be understood, of course, that the foregoing relates to exemplary embodiments of the invention and that modifications may be made without departing from the spirit and scope of the invention as set forth in the following claims. The invention should therefore not be limited by the above described embodiment, method, and examples, but by all embodiments and methods within the scope and spirit of the invention as claimed.

TABLE 1
Method of Scoring the Game Application

| LEVEL | ATTACK | DEFENSE | SUMMON | BONUS |
|---|---|---|---|---|
| 1 | 5 | 10 | x | 5 |
| 2 | 10 | 20 | x | 10 |
| 3 | 15 | 30 | 15/15 | 15 |
| 4 | 20 | 40 | 20/20 | 20 |
| 5 | 25 | 50 | 25/25 | 25 |
| 6 | 30 | 60 | 30/30 | 30 |
| 7 | 35 | 70 | 35/35 | 35 |
| 8 | 40 | 80 | 40/40 | 40 |
| 9 | 45 | 90 | 45/45 | 45 |
| 10 | 45 | 100 | 50/50 | 50 |

What is claimed is:

1. A method for providing input commands for an electronic application, the method comprising:
providing an electronic application capable of being used on a plurality of electronic touch screen devices by one or more users;
providing an application where when the user provides at least two of (1) inputting a specific geometric pattern on the electronic screen, (2) repeatedly inputting a specific section or sections of the electronic screen, (3) inputting the geometric pattern or specific section or sections with a specific rhythm or a specific number of times, the user causes a specific command to be performed in the application.

2. The method of claim 1, wherein inputting specific commands allows the user to retrieve the stored data or perform a specific action or command quickly and securely.

3. The method of claim 1, wherein providing specific input commands that allows the user to control or operate the devices and/or software.

4. The method of claim 1, wherein the one or more users enter the input commands using the input grid.

5. The method of claim 1, wherein the one or more users hold, tap or swipe the one or more dots on the input grid to enter the input commands.

6. The method of claim 1, wherein the one or more users enter the input commands by creating one or more geometric patterns on the input grid.

7. The method of claim 1, further comprising:
linking the one or more touch screen devices to each other by a central game server or over a network.

8. The method of claim 1, further comprising:
sending game signals from one electronic touch screen device to the central game server or over a network.

9. The method of claim 1, wherein the dots of the input grid are transparent.

10. The method of claim 1, wherein the dots of the input grid are overlaid on the screen of the electronic application.

11. The method of claim 1, wherein the input grid is a 3×3 matrix of dots.

12. The method of claim 1, wherein the input grid is a 3×4 matrix of dots.

13. The method of claim 1, wherein the input grid is a 4×3 matrix of dots.

14. The method of claim 1, wherein the input grid is a heart shaped matrix of dots.

15. A system for providing input commands for an electronic application, the system comprising:
a plurality of electronic touch screen devices containing a processor and capable of being used by one or more users;
the touch screen devices including an application where when the user provides at least two of (1) inputting a specific geometric pattern on the electronic screen, (2) repeatedly inputting a specific section or sections of the electronic screen, (3) inputting the geometric pattern or specific section or sections with a specific rhythm or a specific number of times, the user causes a specific command to be performed in the application.

16. The system of claim 15, wherein inputting specific commands allows the user to retrieve the stored data or perform a specific action or command quickly and securely.

17. The system of claim 15, wherein providing specific input commands that allows the user to control or operate the devices and/or software.

18. The system of claim 15, further comprising:
linking the one or more touch screen devices to each other by a central game server or over a network.

19. The system of claim 15, further comprising:
sending game signals from one electronic touch screen device to the central game server or over a network.
